(19) United States
(12) Patent Application Publication
(10) Pub. No.: US 2015/0244564 A1
(43) Pub. Date: Aug. 27, 2015

(54) ACTIVE/STANDBY PW REDUNDANCY FOR EPIPES

(71) Applicant: ALCATEL-LUCENT, Paris (FR)

(72) Inventors: Ian COWBURN, Mouans-Sartoux (FR); Shafiq PIRBHAI, Ottawa (CA); David MOTZ, Ottawa (CA)

(73) Assignee: ALCATEL-LUCENT, Paris (FR)

(21) Appl. No.: 14/190,731

(22) Filed: Feb. 26, 2014

(51) Int. Cl. H04L 12/24

(52) U.S. Cl. CPC H04L 41/0654

(57) ABSTRACT

Various exemplary embodiments relate to a method performed by a backbone network for performing switchover of plurality of pseudo-wires (PWs) connecting a customer edge device to a primary backbone edge bridge (BEB), the method including: designating one of the plurality of PWs as a control PW; associating the remaining PWs with the control PW; associating a virtual backbone MAC (B-MAC) address with the control PW; and advertising, by the primary BEB, the virtual B-MAC address to the backbone network.

### TECHNICAL FIELD

Various exemplary embodiments disclosed herein relate generally to providing redundancy for epipes.

### BACKGROUND

A service provider may provide a virtual leased line (VLL) to provide network bandwidth to a customer. The VLL provides Ethernet based point to point communication over IP/MPLS (Internet Protocol/Multiprotocol Label Switching) networks. VLL uses pseudo-wire (PW) encapsulation for transporting Ethernet traffic over an MPLS tunnel across an IP/MPLS backbone. A service level agreement (SLA) may be associated with the VLL that specifies certain performance requirements of the VLL service, for example, service availability, bandwidth, latency, etc. In order to meet the service availability requirement, redundancy in the service provider network is important in order to handle failures without affecting the service availability to the customers and to minimize service outages.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments relate to a method performed by a backbone network for performing switchover of plurality of pseudo-wires (PWs) connecting a customer edge device to a primary backbone edge bridge (BEB), the method including: designating one of the plurality of PWs as a control PW; associating the remaining PWs with the control PW; associating a virtual backbone MAC (B-MAC) address with the control PW; and advertising, by the primary BEB, the virtual B-MAC address to the backbone network.

Various embodiments relate to a network device for performing switchover of plurality of pseudo-wires (PWs) connecting a customer edge device to a primary backbone edge bridge (BEB), the network device including: a network interface; and a processor configured to: designate one of the plurality of PWs as a control PW; associate the remaining PWs with the control PW; associate a virtual backbone MAC (B-MAC) address with the control PW; and advertise the virtual B-MAC address to the backbone network.

Various embodiments relate to a non-transitory machine-readable storage medium encoded with instructions for execution by a backbone network for performing switchover of plurality of pseudo-wires (PWs) connecting a customer edge device to a primary backbone edge bridge (BEB), the non-transitory machine-readable storage medium including: instructions for designating one of the plurality of PWs as a control PW; instructions for associating the remaining PWs with the control PW; instructions for associating a virtual backbone MAC (B-MAC) address with the control PW; and instructions for advertising, by the primary BEB, the virtual B-MAC address to the backbone network.

### BRIEF DESCRIPTION OF THE DRAWINGS

In order to better understand various exemplary embodiments, reference is made to the accompanying drawings, wherein:

FIG. 1 illustrates a VLL network implementation;

FIG. 2 illustrates a portion of the VLL network used to illustrate the implementation of a virtual B-MAC address and a control PW;

FIGS. 3 and 4 illustrate the switch over of PWs from a failed BEB to a redundant BEB; and

FIG. 5 illustrates an exemplary hardware diagram 500 for implementing a customer edge device, BEB, or BCB.

To facilitate understanding, identical reference numerals have been used to designate elements having substantially the same or similar structure or substantially the same or similar function.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

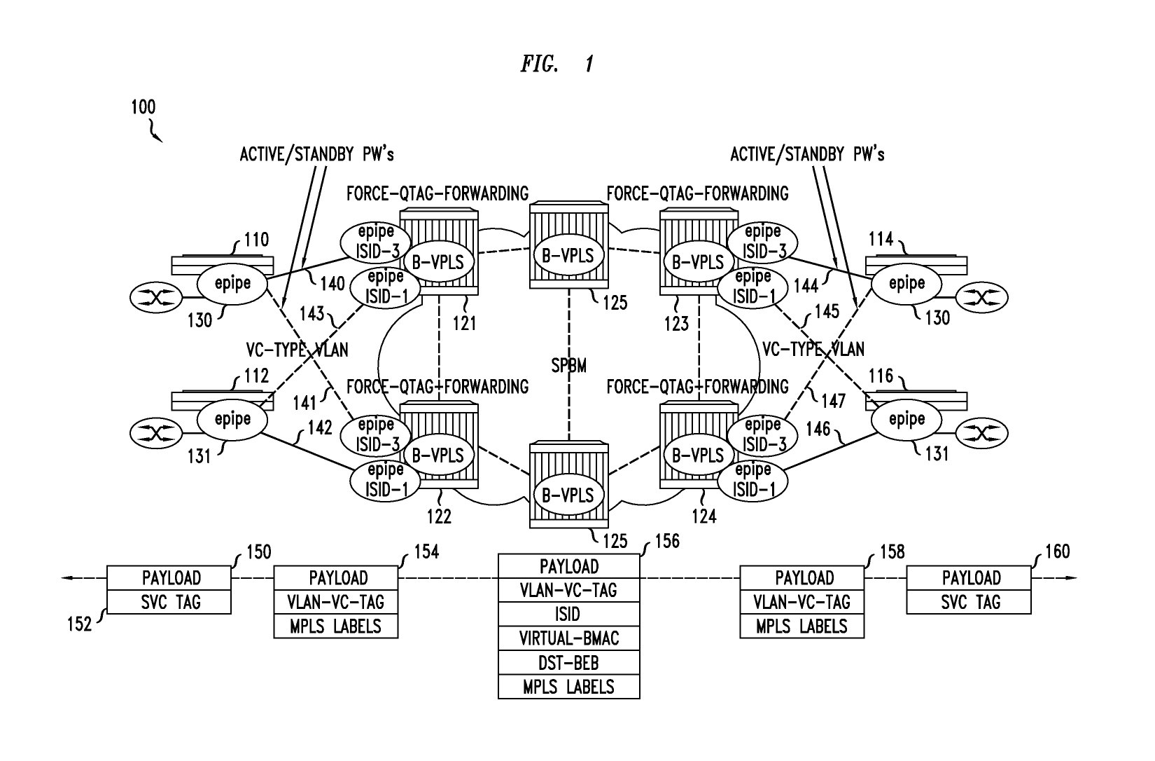

FIG. 1 illustrates a VLL network implementation. The VLL network 100 may include customer edge devices 110-116 and service provider backbone network (SBB) 120. The customer edge devices 110-116 receive data from the customer that is to be transported across the service provider network. The customer edge devices 110-116 may service one customer or many customers depending upon the bandwidth requirements of the customers. Further, the customer edge devices 110-116 may be located at a customer or service provider site depending upon the specific network. Also, the customer edge devices 110-116 may be owned by either the customer or the service provider.

The SBB 120 includes provider backbone edge bridges (BEB) 121-124 as well as backbone core bridges (BCB) 125. The BEBs 121-124 communicate with the customer edge devices 110-116 and provide the entryway for customer data to the provider backbone 120. The other network devices 125 provide network routing for data in the SBB 120. A B-VPLS (backbone virtual private local area network service) may be implemented on the BEBs 121-124 and BCBs 125 to provide for the communication of data across the SBB 120. The SBB 120 uses bridging to hide the internal complexity of the backbone network from the customer.

The customer edge devices 110-116 may use epipes 130, 131 to communicate with the BEBs 121-124. Epipes 130, 131 are an implementation of the VLL that emulates a point-to-point Ethernet service. The epipes 130, 131 may include many PWs. Also, epipe 130 may be associated with a first VLL and include PWs 140, 141, 144, 145, and epipe 131 may be associated with a second VLL and include PWs 142, 143, 146, 174. Further, PWs 140-148 are illustrated that connect the customer edge devices 110-116 to the BEBs 121-124 over the epipes 130, 131.

FIG. 1 also illustrates the flow of a data payload 150 though the VLL network. The customer edge device 110 receives the customer data including the payload 150 with a service tag associated with the payloadinthe packet 152. At the customer edge device 110, the service tag may be stripped off and a vlan-vc-tag and a MPLS label added to the payload to form a new packet 154. This packet 154 is then sent to BEB 121. The BEB 121 then adds additional tags and labels (e.g., ISID, virtual-BMAC, Dst-BEB) to help direct the packet 156 through the SBB 120. The packet 156 is then received by BEB 123 where the additional tags and labels are stripped off to result in packet 158. Next, the packet 158 is received by the customer edge device 114, where the vlan-vc-tag and MPLS label are stripped off and the service tag added, resulting in 160 sent to the customer.

When active/standby PWs are implemented from an edge device 110 into an epipe 130 and when a failover occurs, the customer edge device 110 moves traffic from the failed active PW 140 to the standby PW 141. As a result the traffic from customer edge device 110 now flows to the redundant BEB 122. A remote BEB 123 in communication with BEB 121 would continue to send traffic to BEB 121 until it discovers that is should now be sending it to BEB 122. Also, the PW 140 becomes inactive and the standby PW 141 becomes active.

In a solution based on I-VPLS (I-VPLS is VPLS facing the customer), active/standby switchover from, for example BEB 121 to BEB 122, is handled by either BEB 121 or BEB 122 sending a MAC flush to BEB 123 over MPLS backbone connections so that all of the customer MAC relationship to BEB 121 backbone MAC can be cleared. This would cause BEB 123 to flood traffic to both BEB 121 and BEB 122 until BEB 123 receives customer traffic from BEB 122 in order for it to re-learn the backbone MAC of the device to which it should send this customer traffic (BEB 122).

There is no MAC flush mechanism for provider backbone (PBB) epipe services to inform BEB 123 to clear the customer MAC relationship to BEB 121 backbone MAC, which would mean that a failover would result in uni-directional traffic, and therefore a permanent outage.

This problem may be solved by the use of a virtual backbone MAC representing the edge device service used by either BEB 121 or BEB 122 when they are connected to the active PW. This allows BEB 122 to inform other BEBs in SBB 120 that it is the owner of the virtual backbone MAC and so the destination for the service traffic immediately after the PW becomes active on BEB 122, therefore restoring bi-directionally communications. The use of shortest path bridging MAC (SPBM) along with introducing a control PW in the mechanism also allows this solution to scale to the level required in a service provider network where thousands of PW's may be present and need to be managed.

In the embodiments described below, support has been added to allow a remote device configured with a service using active/standby PWs to connect to a PW, configured appropriately, in a PBB epipe. In order for the PBB core to send traffic to the BEB connected to the active PW, a virtual PBB backbone MAC (vBMAC) is associated with the remote service and may announced by the BEB to which the active PW is connected into the PBB core using SPBM. While the use of the SPBM protocol is described herein other protocols that provide the ability to announce the vBMAC to the PBB backbone may be used as well.

When multiple PBB Epipe PWs exist on the same service distribution point (SDP) connecting to active/standby PWs, one PW may be configured to be the control PW and the vBMAC is announced based on the status of this control PW. Other PWs using the same SDP can be configured to be associated with the control PW and assumed to be in the same state as the control PW.

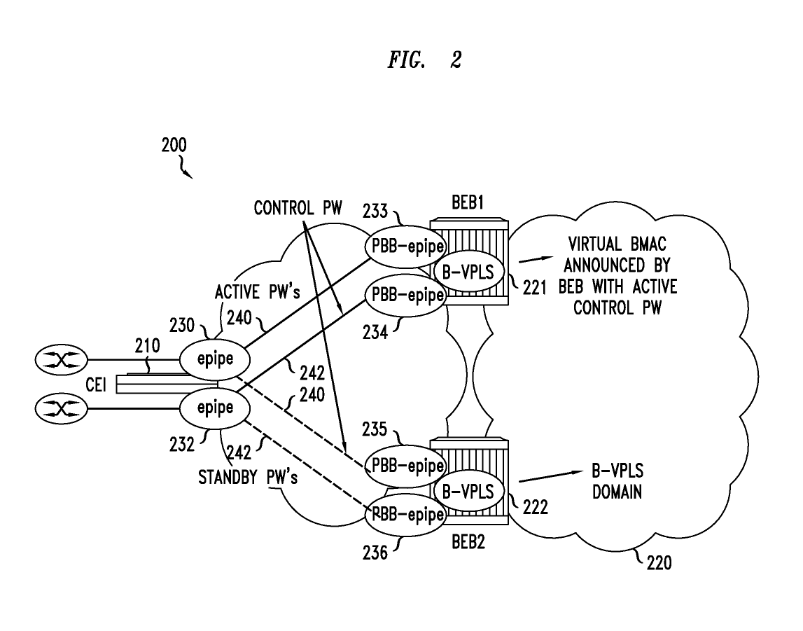

FIG. 2 illustrates a portion of the VLL network used to illustrate the implementation of a virtual B-MAC address and a control PW. The elements of the VLL network 200 correspond to similar elements found in the VLL network 100 of FIG. 1. The VLL network 200 includes customer edge device 210, epipes 230, 232, PBB-epipes 233-236, control PW 240, other PW 242, BEBs 221, 222 and SBB 220. The operation of this network will now be described.

In order to support PW redundancy to two different BEBs 221, 222, a virtual B-MAC may be associated with the active PW 240 that is used as the source B-MAC for traffic forwarded from the active PW 240 into the PBB network 220. On a failover the active PW 240 moves to the other peer BEB 222 and traffic is then forwarded from the peer BEB 222 using the same source virtual B-MAC. The remote epipe PBB tunnel is configured with the virtual B-MAC as its backbone destination MAC address in order that traffic is directed to the BEB with the active PW 240.

The new location of the virtual B-MAC in the data plane may be advertised using SPBM to the other BEB/BCBs via the control plane. The virtual B-MAC may be configured on a per-SDP basis using a control PW because having the configuration on a per-PW basis is not considered to be scalable. Further, the virtual B-MAC and control PW may be configured for any logical group of the PWs that may be present in the network.

It may be possible to support both non-redundant and redundant PWs on PBB Epipes associated with the same B-VPLS. It may also be possible to support both non-redundant and redundant PWs on PBB Epipes using the same SDP.

Typically the decision of which of the redundant PWs is active will be dependent on the configuration of the customer edge device 210 and may be signaled accordingly to the PBB-epipe systems using either the PW status bits or by withdrawing the labels.

Now the operation and configuration of the control PW is described. In the example of an all spoke-SDP, all of the PWs on any given SDP will be in the same state on a given BEB, that is, either all active or all standby. However, as the state is signaled per PW, this cannot be guaranteed. In order to ensure that the virtual B-MAC is only advertised from one of the peer BEBs when there are active PWs on an SDP on both BEBs, the advertisement of the virtual B-MAC by SPBM will be based on the state of a single PW which is the control PW.

The control PW may be configured using a configuration command. The operator should ensure that the same PW is configured as the control PW on both peering BEBs, otherwise SPBM may advertise the virtual B-MAC from both BEBs if the PWs are not both active on the same BEB. As a result, the control PW may be changed dynamically without shutting down the PWs, SDP or withdrawing the SPBM advertisement of the virtual BMAC, this allows a graceful change of the control PW. The change should be done on both BEBs as close in time as possible to avoid an asymmetric configuration, ensuring that during the change the new control PW is in the same state as the current control PW on both peering BEBs.

When multiple redundant PWs are configured on an SDP and some of these PWs become active on the standby BEB 222 (i.e., the BEB 222 on which the control PW is in a standby state) traffic received on those PWs will be forwarded into the B-VPLS, but will use the source-bmac instead of the virtual B-MAC as their source MAC. This, however, will continue to allow bi-directional traffic for the related customers as the return traffic will be sent to the virtual B-MAC based on the epipe PBB tunnel configuration, i.e., to the BEB with the active control PW, and as long as the non-control PW is in standby state it will be used to send traffic to the customer edge device 210. If this operation is not desired for any reason, it is possible to prevent traffic being sent on a standby PW using the standby-signaling-slave parameter under the spoke-sdp definition.

In order to allow the use of active/standby PWs, the following configuration steps may be used. First the virtual B-MAC may be configured. For example, information from a specific SDP spoke and information from the PBB source B-MAC may be combined to create the virtual B-MAC. Accordingly, the virtual B-MAC is used as the source backbone MAC for traffic received on the PBB epipe spoke-SDP when forwarded into the B-VPLS domain when the control PW is active on this BEB.

Next, a control PW may be configured, using control PW ID parameter. This indicates to SPBM that the advertising of the virtual B-MAC for this SDP is determined by the status of the PW identified by the control PW ID parameter. It is noted, that the control PW ID parameter may be added, removed or changed when the SDP is either up or down. Typically, the virtual B-MAC will only be advertised when the control PW ID parameter is configured. Further, the virtual B-MAC may only be advertised when spoke-SDP referenced by the control PW ID is configured to allow for a control PW ID and when the spoke-SDP referenced by the control PW ID is operational.

The control PW ID may be dynamically changed to another PW on the associated SDP without shutting down either the SDP or the related spoke-SDPs. But, if the PW does not exist or is not configured to be used as a control PW, the control PW is considered to be not active and the virtual B-MAC is not advertised by SPBM for this SDP.

Further, in the redundant BEB 222 the redundant PW should be configured to be used as a control PW under the related spoke-SDP. When the control PW is active on the redundant BEB 222, traffic received on this spoke-SDP will be sent into the B-VPLS using the virtual B-MAC as the source MAC.

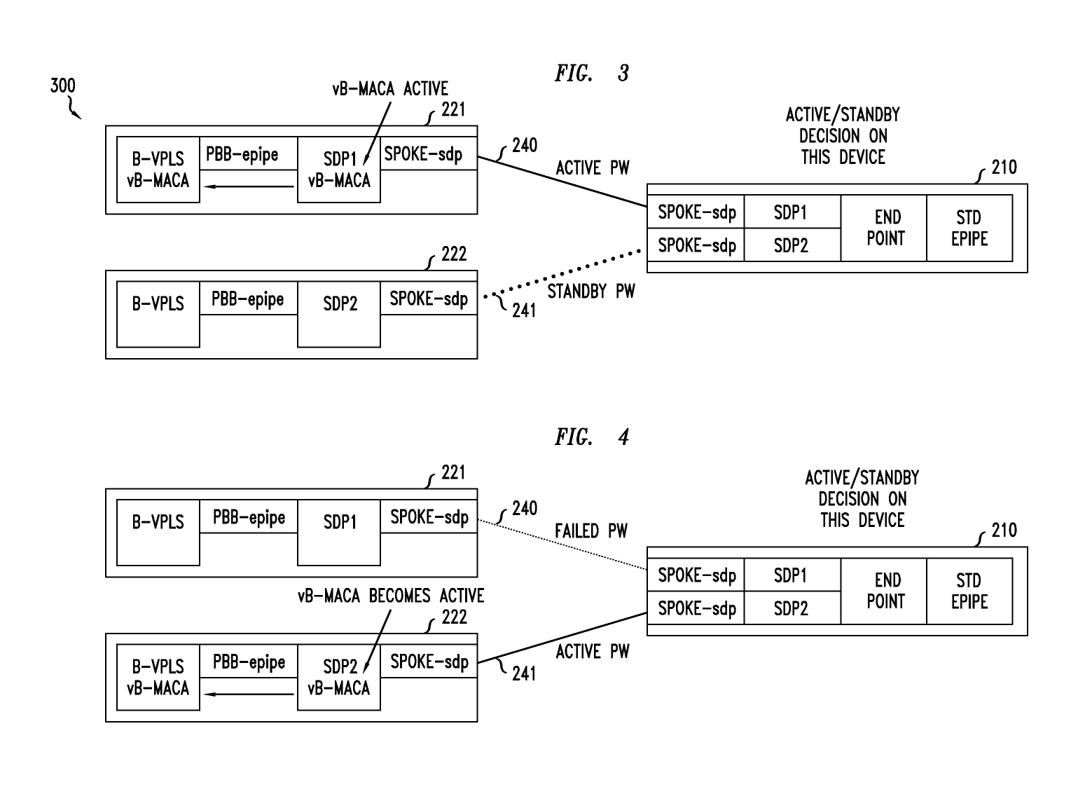

FIGS. 3 and 4 illustrate the switch over of PWs from a failed BEB to a redundant BEB. In FIG. 3 BEB 221 is connected to the customer edge device 210 using an active PW 240. Further, the virtual B-MAC is active in the BEB 221, which advertised the virtual B-MAC address so that it would receive traffic to the customer edge device 210. Further, the redundant BEB 220 is connected to the customer edge device 210 using a standby PW 241. In this case the virtual B-MAC is not active in BEB 222. When the customer edge device 210 determines that there is a failure related to the active PW 240, it switches the customer edge device to connect to the redundant BEB 222 using the standby PW 241, which now becomes the active PW as shown in FIG. 4. Now, the virtual B-MAC becomes active on the redundant BEB 222 and inactive on BEB 221. Further, as the PW 240 is the control PW, any associated PWs are expected to also switch over to the redundant BEB 222. As a result the number of messages needed to switch a large number of PWs during a fail over is greatly reduced.

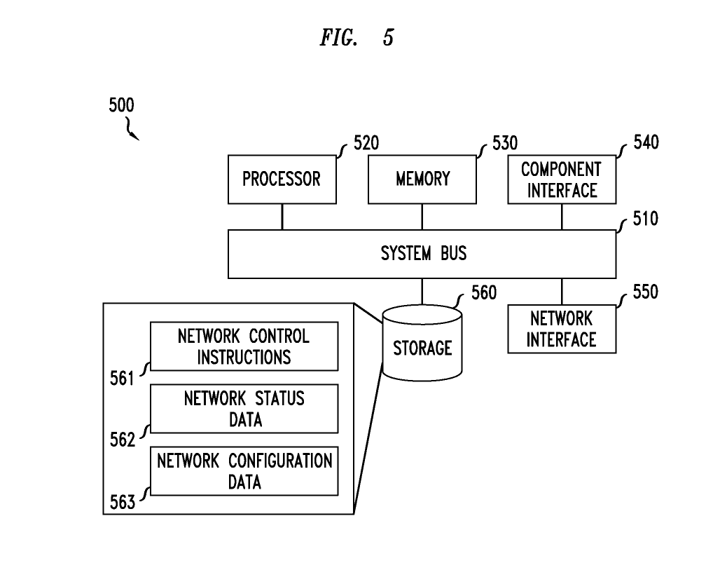

FIG. 5 illustrates an exemplary hardware diagram 500 for implementing a customer edge device, BEB, or BCB. The exemplary hardware 500 may correspond to any of the customer edge devices, BEBs or BCS of the networks 100, 200, 300, or 400. As shown, the hardware 500 includes a processor 520, memory 530, component interface 540, network interface 550, and storage 560 interconnected via one or more system buses 510. It will be understood that FIG. 5 constitutes, in some respects, an abstraction and that the actual organization of the components of the hardware 500 may be more complex than illustrated.

The processor 520 may be any hardware device capable of executing instructions stored in memory 530 or storage 560. As such, the processor may include a microprocessor, field programmable gate array (FPGA), application-specific integrated circuit (ASIC), or other similar devices.

The memory 530 may include various memories such as, for example L1, L2, or L3 cache or system memory. As such, the memory 530 may include static random access memory (SRAM), dynamic RAM (DRAM), flash memory, read only memory (ROM), or other similar memory devices.

The component interface 540 may include one or more devices communicating with other components within a system of which the hardware is a part. For example, the component interface 540 may enable communication with a network processor where the hardware 500 implements a control plane. Likewise, the component interface 540 may enable communication with a control plane where the hardware 500 implements a network processor. Accordingly, the component interface 540 may receive event indications such as, for example, re-key threshold indications and anti-replay connection ownership indications. Various hardware interfaces for enabling such intrasystem communication will be apparent.

The network interface 550 may include one or more devices for enabling communication with other hardware devices. For example, the network interface 550 may include a network interface card (NIC) configured to communicate according to the Ethernet protocol. Additionally, the network interface 550 may implement a TCP/IP stack for communication according to the TCP/IP protocols. Various alternative or additional hardware or configurations for the network interface 550 will be apparent.

The storage 560 may include one or more machine-readable storage media such as read-only memory (ROM), random-access memory (RAM), magnetic disk storage media, optical storage media, flash-memory devices, or similar storage media. In various embodiments, the storage 560 may store instructions for execution by the processor 520 or data upon which the processor 520 may operate. For example, the storage 560 may store network control instructions 561 for coordinating basic network processor functionality such as receiving packets, determining a next hop, forwarding packets, and reporting events. Also, these instructions may manage the various protocols implemented on the hardware 500. For example, the network control instructions 561 include instructions for setting up and managing PWs including control PWs. In the case of a customer edge device the network control instructions 561 may include instructions for detecting a failure of a PW and instructions to carry out the switch over of the PWs. In the case of a BEB, the network control instructions 561 may include instructions for advertising a virtual B-MAC or for selecting and configuring a control PW and its associated PWs. The network status data 562 may include, for example, information regarding the status of the various PWs. The network configuration data may include information such as the control PW ID and virtual B-MAC address.

It will be apparent that various information described as stored in the storage 560 may be additionally or alternatively stored in the memory 530. In this respect, the memory 530 may also be considered to constitute a “storage device.” Various other arrangements will be apparent. Further, the memory 530 and storage 560 may both be considered to be “non-transitory machine-readable media.” As used herein, the term “non-transitory” will be understood to exclude transitory signals but to include all forms of storage, including both volatile and non-volatile memories.

While the hardware 500 is shown as including one of each described component, the various components may be duplicated in various embodiments. For example, the processor 520 may include multiple microprocessors that are configured to independently execute the methods described herein or are configured to perform steps or subroutines of the methods described herein such that the multiple processors cooperate to achieve the functionality described herein. Various other arrangements will be apparent.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a backbone network for performing switchover of plurality of pseudo-wires (PWs) connecting a customer edge device to a primary backbone edge bridge (BEB), the method comprising:
designating one of the plurality of PWs as a control PW;
associating the remaining PWs with the control PW;
associating a virtual backbone MAC (B-MAC) address with the control PW; and
advertising, by the primary BEB, the virtual B-MAC address to the backbone network.

2. The method of claim 1, further comprising:
initiating a switch over by a customer edge device of the plurality of PWs from the primary BEB to a plurality of redundant PWs connected to the redundant BEB; and
advertising by the redundant BEB the virtual B-MAC address to the backbone network.

3. The method of claim 2, further comprising:
designating one of the plurality of redundant PWs as the control PW.

4. The method of claim 1, wherein the virtual B-MAC address is associated with the primary BEB and the secondary BEB.

5. The method of claim 1, wherein the virtual B-MAC address is advertised using the shortest path bridging MAC (SPBM) protocol.

6. The method of claim 1, wherein the plurality of PWs are all on a service distribution point (SDP).

7. The method of claim 6, wherein the plurality of PWs include all of the PWs on the service distribution point (SDP).

8. A network device for performing switchover of plurality of pseudo-wires (PWs) connecting a customer edge device to a primary backbone edge bridge (BEB), the network device comprising:
a network interface; and
a processor configured to:
designate one of the plurality of PWs as a control PW;
associate the remaining PWs with the control PW;
associate a virtual backbone MAC (B-MAC) address with the control PW; and
advertise the virtual B-MAC address to the backbone network.

9. The network device of claim 8, wherein the virtual B-MAC address is associated with the primary BEB and the secondary BEB.

10. The network device of claim 8, wherein the virtual B-MAC address is advertised using the shortest path bridging MAC (SPBM) protocol.

11. The network device of claim 8, wherein the plurality of PWs are all on a service distribution point (SDP).

12. The network device of claim 8, wherein the plurality of PWs include all of the PWs on the service distribution point (SDP).

13. A non-transitory machine-readable storage medium encoded with instructions for execution by a backbone network for performing switchover of plurality of pseudo-wires (PWs) connecting a customer edge device to a primary backbone edge bridge (BEB), the non-transitory machine-readable storage medium comprising:
instructions for designating one of the plurality of PWs as a control PW;
instructions for associating the remaining PWs with the control PW;
instructions for associating a virtual backbone MAC (B-MAC) address with the control PW; and
instructions for advertising, by the primary BEB, the virtual B-MAC address to the backbone network.

14. The non-transitory machine-readable storage medium of claim 13, further comprising:
instructions for initiating a switch over by a customer edge device of the plurality of PWs from the primary BEB to a plurality of redundant PWs connected to the redundant BEB; and
instructions for advertising by the redundant BEB the virtual B-MAC address to the backbone network.

15. The non-transitory machine-readable storage medium of claim 14, further comprising:
instructions for designating one of the plurality of redundant PWs as the control PW.

16. The non-transitory machine-readable storage medium of claim 13, wherein the virtual B-MAC address is associated with the primary BEB and the secondary BEB.

17. The non-transitory machine-readable storage medium of claim 13, wherein the virtual B-MAC address is advertised using the shortest path bridging MAC (SPBM) protocol.

18. The non-transitory machine-readable storage medium of claim 13, wherein the plurality of PWs are all on a service distribution point (SDP).

19. The non-transitory machine-readable storage medium of claim 13, wherein the plurality of PWs include all of the PWs on the service distribution point (SDP).
